(19) United States
(12) Patent Application Publication
(10) Pub. No.: US 2026/0231255 A1
(43) Pub. Date: Aug. 6, 2026

(54) DATA TRANSMISSION METHOD AND RELATED APPARATUS

(71) Applicant: Tencent Technology (Shenzhen) Company Limited, Shenzhen (CN)

(72) Inventor: Yuan YAN, Shenzhen (CN)

(73) Assignee: Tencent Technology (Shenzhen) Company Limited, Shenzhen (CN)

(21) Appl. No.: 19/575,132

(22) Filed: Mar. 23, 2026

Related U.S. Application Data
(63) Continuation of application No. PCT/CN2024/118388, filed on Mar. 12, 2024.

(30) Foreign Application Priority Data
Nov. 29, 2023 (CN) 202311623452.0

(51) Int. Cl. H04W 76/12; H04W 76/11; H04W 80/06

(52) U.S. Cl. CPC H04W 76/12; H04W 76/11; H04W 80/06

(57) ABSTRACT

Disclosed in this application are a data transmission method and a related apparatus. The method includes: initiating, in a first network environment, a connection request for a second terminal device, to obtain a first connection identifier and a second connection identifier that are used for the first network environment, the first terminal device and the second terminal device being located in the first network environment, and the first network environment comprising a transmission gateway used for data packet forwarding; requesting to establish a first data transmission tunnel with the transmission gateway according to the first connection identifier, and requesting to establish a second data transmission tunnel with the transmission gateway according to the second connection identifier; and performing data transmission with the second terminal device via the first data transmission tunnel or the second data transmission tunnel.

### RELATED APPLICATION

This application is a continuation application of PCT Patent Application No. PCT/CN2024/118388, filed on September 12, 2024, which claims priority to Chinese Patent Application No. 202311623452.0, filed with the China National Intellectual Property Administration on November 29, 2023, each of which is incorporated herein by reference in its entirety.

### FIELD OF THE TECHNOLOGY

This application relates to the field of data processing, and in particular, to a data transmission technology.

### BACKGROUND OF THE DISCLOSURE

In a network environment, terminal devices may perform data transmission between each other by establishing a connection, so as to implement various real-time functions, such as a video call and voice interaction.

However, when a transmission problem occurs in the connection between the terminal devices based on various reasons, implementation of the foregoing real-time functions may be seriously affected, for example, unbearable time delay, audio and video asynchronization, or even function interruption occurs.

Therefore, how to improve data transmission stability is a problem that needs to be urgently resolved currently.

### SUMMARY

To solve the foregoing technical problem, this application provides a data transmission method and a related apparatus. Two independent data transmission tunnels can be established between two terminal devices, so that an effective fault tolerance basis is provided due to the dual data transmission tunnels, thereby greatly improving the stability of data transmission.

Embodiments of this disclosure disclose the following technical solutions.

According to an aspect, an embodiment of this disclosure provides a data transmission method, the method being performed by a first terminal device, and including:

initiating, in a first network environment, a connection request for a second terminal device to obtain a first connection identifier and a second connection identifier that are used for the first network environment, the first terminal device and the second terminal device being located in the first network environment, and the first network environment including a transmission gateway used for data packet forwarding;

requesting to establish a first data transmission tunnel with the transmission gateway according to the first connection identifier, and requesting to establish a second data transmission tunnel with the transmission gateway according to the second connection identifier; and

performing data transmission with the second terminal device by using the first data transmission tunnel or the second data transmission tunnel.

According to another aspect, an embodiment of this disclosure provides another data transmission method, the method being performed by a forwarding node in a first network environment, and including:

determining, when obtaining a data packet sent by a first terminal device to a second terminal device, a to-be-identified connection identifier carried in the data packet, the first terminal device and the second terminal device being located in the first network environment;

forwarding, in response to that the to-be-identified connection identifier is a first connection identifier in a first connection identifier set, the data packet to the second terminal device by using a target data transmission tunnel, the target data transmission tunnel being a data transmission tunnel established between the second terminal device and the forwarding node by using the first connection identifier; and

forwarding, in response to that the to-be-identified connection identifier is a second connection identifier in a second connection identifier set, the data packet to a transmission gateway in the first network environment by using a second data transmission tunnel, to cause the transmission gateway to forward the data packet to the second terminal device by using a third data transmission tunnel.

According to another aspect, an embodiment of this disclosure provides a data transmission apparatus, deployed on a first terminal device, the apparatus including: an obtaining module, an establishment module, and a transmission module,

the obtaining module being configured to initiate, in a first network environment, a connection request for a second terminal device to obtain a first connection identifier and a second connection identifier that are used for the first network environment, the first terminal device and the second terminal device being located in the first network environment, and the first network environment including a transmission gateway used for data packet forwarding;

the establishment module being configured to request to establish a first data transmission tunnel with the transmission gateway according to the first connection identifier, and request to establish a second data transmission tunnel with the transmission gateway according to the second connection identifier; and

the transmission module being configured to perform data transmission with the second terminal device by using the first data transmission tunnel or the second data transmission tunnel.

According to another aspect, an embodiment of this disclosure provides another data transmission apparatus, deployed on a forwarding node in a first network environment, the apparatus including: a determining module, a first forwarding module, and a second forwarding module,

the determining module being configured to determine, when obtaining a data packet sent by a first terminal device to a second terminal device, a to-be-identified connection identifier carried in the data packet, the first terminal device and the second terminal device being located in the first network environment;

the first forwarding module being configured to forward, in response to that the to-be-identified connection identifier is a first connection identifier in a first connection identifier set, the data packet to the second terminal device by using a target data transmission tunnel, the target data transmission tunnel being a data transmission tunnel established between the second terminal device and the forwarding node by using the first connection identifier; and

the second forwarding module being configured to forward, in response to that the to-be-identified connection identifier is a second connection identifier in a second connection identifier set, the data packet to a transmission gateway in the first network environment by using a second data transmission tunnel, to cause the transmission gateway to forward the data packet to the second terminal device by using a third data transmission tunnel.

According to still another aspect, an embodiment of this disclosure provides a computer device. The computer device includes a processor and a memory.

The memory is configured to store a computer program and transmit the computer program to the processor.

The processor is configured to perform, according to the computer program, the method in the foregoing aspects.

According to still another aspect, an embodiment of this disclosure provides a computer-readable storage medium. The computer-readable storage medium is configured to store a computer program. The computer program is configured for performing the method in the foregoing aspects.

According to still another aspect, an embodiment of this disclosure provides a computer program product including a computer program. The computer program, when run on a computer device, causes the computer device to perform the method in the foregoing aspects.

It can be seen from the foregoing technical solutions that, for the first terminal device and the second terminal device that are located in the first network environment, when preparing to connect to the second terminal device, the first terminal device may obtain the first connection identifier and the second connection identifier by initiating a connection request. The first terminal device separately requests to establish the first data transmission tunnel and the second data transmission tunnel with the transmission gateway in the first network environment according to the two connection identifiers. The first terminal device may select, based on a case of the two data transmission tunnels, the first data transmission tunnel or the second data transmission tunnel to send the data packet for the second terminal device, to forward the data packet to the second terminal device in the first network environment by using the transmission gateway. By establishing two independent data transmission tunnels between two terminal devices in a single network environment, even if a transmission problem occurs in one data transmission tunnel, data transmission may be continued by using the other data transmission tunnel, so that an effective fault tolerance basis is provided due to the dual data transmission tunnels, thereby greatly improving the stability of data transmission.

### BRIEF DESCRIPTION OF THE DRAWINGS

To describe technical solutions of embodiments of this disclosure or the related art more clearly, the following briefly introduces accompanying drawings required for describing the embodiments or the related art. Apparently, the accompanying drawings in the following description show only some embodiments of this disclosure, and a person of ordinary skill in the art may still derive other drawings from these accompanying drawings without creative efforts.

FIG. 1 is a schematic diagram of a data transmission method according to an embodiment of this disclosure.

FIG. 2 is a flowchart of a data transmission method according to an embodiment of this disclosure.

FIG. 3 is a schematic diagram of redundancy transmission according to an embodiment of this disclosure.

FIG. 4 is a schematic diagram of aggregation transmission according to an embodiment of this disclosure.

FIG. 5 is a schematic diagram of an architecture of a multi-network transmission system according to an embodiment of this disclosure.

FIG. 6 is a diagram of an architecture of a 5G LAN according to an embodiment of this disclosure.

FIG. 7 is a schematic diagram of a structure of a 5G LAN according to an embodiment of this disclosure.

FIG. 8 is a schematic diagram of a quick user datagram protocol (UDP) Internet connections (QUIC) protocol stack according to an embodiment of this disclosure.

FIG. 9 is a schematic diagram of a structure of a QUIC data packet format according to an embodiment of this disclosure.

FIG. 10 is a schematic diagram of a data transmission method in a multi-network scenario according to an embodiment of this disclosure.

FIG. 11 is a signaling diagram of a data transmission method according to an embodiment of this disclosure.

FIG. 12 is a signaling diagram of a data transmission method according to an embodiment of this disclosure.

FIG. 13 is a schematic apparatus diagram of a data transmission apparatus according to an embodiment of this disclosure.

FIG. 14 is a schematic apparatus diagram of another data transmission apparatus according to an embodiment of this disclosure.

FIG. 15 is a schematic diagram of a structure of a data transmission system according to an embodiment of this disclosure.

FIG. 16 is a structural diagram of a terminal device according to an embodiment of this disclosure.

FIG. 17 is a structural diagram of a server according to an embodiment of this disclosure.

### DESCRIPTION OF EMBODIMENTS

Embodiments of this disclosure are described below with reference to the accompanying drawings.

In a current network transmission process, terminal devices may choose to perform data transmission between each other by establishing a connection. In this way, a real-time function between the devices may be implemented by using data transmission. However, in the network transmission process, the connection established between the terminal devices may cause a problem in data transmission due to some emergency reasons. When a problem occurs in data transmission, functions that need to be implemented between the terminal devices cannot be successfully implemented, which further affects user experience of users corresponding to the terminal devices.

Therefore, the embodiments of this disclosure provide a data transmission method and a related apparatus. Two independent data transmission tunnels are established between two terminal devices, so that an effective fault tolerance basis is provided due to the dual data transmission tunnels, thereby greatly improving the stability of data transmission.

The data transmission method provided in this embodiment of this disclosure may be implemented by using a computer device. The computer device may be a terminal device or a server. The server may be an independent physical server, may be a server cluster or a distributed system including a plurality of physical servers, or may be a cloud server providing a cloud computing service. The terminal device includes, but is not limited to, a mobile phone, a computer, an intelligent voice interaction device, an intelligent household appliance, an on-board terminal, an aircraft, an Extended Reality (XR) device, and the like. The terminal device and the server may be directly or indirectly connected in a wired or wireless communication protocol, which is not limited in this application. The data transmission method is applicable to scenarios such as virtual human, digital human, games, and extended reality.

First, several noun terms that may be involved in the following embodiments of this disclosure are explained.

Multi-network transmission system: It is a network system in which there is a plurality of network environments that can be configured to support data transmission between terminal devices. The data transmission method provided in the embodiments of this disclosure may be used for the multi-network transmission system.

Multipath transmission technology (Multipath QUIC (MP-QUIC)): It is an improved QUIC protocol, mainly characterized by supporting transmission of a plurality of data transmission tunnels, and being capable of transmitting data by using a plurality of data transmission tunnels simultaneously, thereby improving reliability and efficiency of data transmission.

5G local area network (5G LAN) technology application: By using the 5G technology, terminal devices are "grouped" or "placed in a group" to form an LAN.

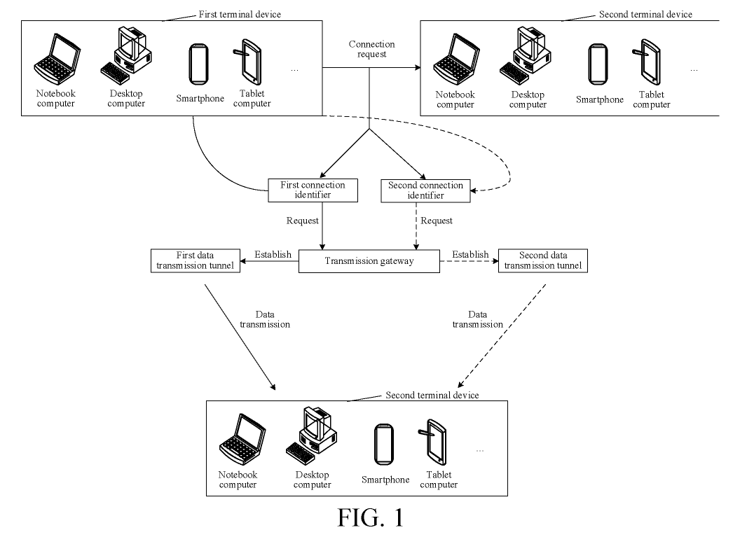

FIG. 1 is a schematic diagram of a data transmission method according to an embodiment of this disclosure. The foregoing computer device is a terminal device.

As shown in FIG. 1, assuming that a first terminal device and a second terminal device are both located in the same network environment, the first terminal device initiates a connection request to the second terminal device, and a first connection identifier and a second connection identifier of the first terminal device in the network environment may be obtained by using the connection request. The first terminal device requests to establish a first data transmission tunnel with the transmission gateway according to the first connection identifier, and requests to establish a second data transmission tunnel with the transmission gateway according to the second connection identifier. The first terminal device may perform data transmission with the second terminal device by using the first data transmission tunnel or the second data transmission tunnel.

The data transmission tunnel between the first terminal device and the transmission gateway that the first terminal device requests to establish may include a forwarding node (not shown in the figure). The forwarding node may be configured to identify, in a process in which the first terminal device sends a data packet to the second terminal device, a to-be-identified connection identifier carried in the data packet, and determine, according to an identification result, a data transmission tunnel for forwarding the data packet to the second terminal device, so as to complete data transmission between the first terminal device and the second terminal device.

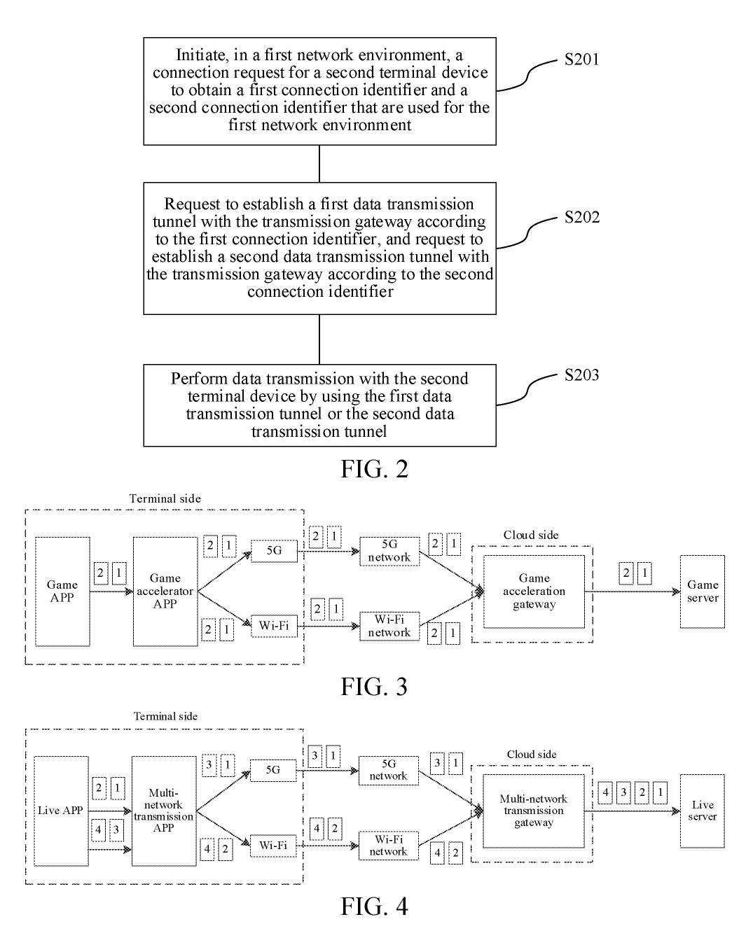

FIG. 2 is a flowchart of a data transmission method according to an embodiment of this disclosure. The method may be performed by a first terminal device. In this embodiment, the aforementioned computer device is the first terminal device.

The method includes:

S201: Initiate, in a first network environment, a connection request for a second terminal device to obtain a first connection identifier and a second connection identifier that are used for the first network environment.

Network environments are various wired or wireless transmission media used to provide a data transmission service, such as a 5th-Generation Mobile Communication Technology (5G) and a wireless-fidelity network communication technology (Wi-Fi). The first network environment mentioned in this embodiment of this disclosure and the second network environment that appears subsequently belong to different network environments.

In this embodiment, the first terminal device and the second terminal device are located in the same network environment. For example, in the first network environment, the first network environment includes a transmission gateway used for data packet forwarding. In the first network environment, when the first terminal device initiates a connection request to the second terminal device, the first terminal device can obtain two connection identifiers applicable to the first network environment. One connection identifier is used for uniquely identifying a data transmission tunnel. Different connection identifiers are used for identifying different data transmission tunnels. The first terminal device may request to establish a data transmission tunnel between the first terminal device and the second terminal device in the first network environment by using the connection identifier. To be specific, different connection identifiers may correspond to different data transmission tunnels, and the first terminal device may request to establish different data transmission tunnels with the transmission gateway according to different connection identifiers.

The transmission gateway mentioned above may be understood as a device or software connecting two different networks or protocols. The transmission gateway can implement data conversion and relay between different networks, to ensure that the networks can communicate with each other. For example, the transmission gateway may be a physical device, such as a router, a switch, or a firewall, or may be a software entity, such as protocol conversion software.

S202: Request to establish a first data transmission tunnel with the transmission gateway according to the first connection identifier, and request to establish a second data transmission tunnel with the transmission gateway according to the second connection identifier.

Different connection identifiers mentioned above may correspond to different data transmission tunnels. Specifically, a request may be made to establish a first data transmission tunnel with the transmission gateway according to the first connection identifier, and a request may be made to establish a second data transmission tunnel with the transmission gateway according to the second connection identifier. The aforementioned connection identifiers may be understood as identifiers that can be used for distinguishing data transmission tunnels. Data transmission tunnels correspondingly requested to be established according to different connection identifiers are also different. To be specific, the first data transmission tunnel and the second data transmission tunnel are two different data transmission tunnels.

To be specific, the connection identifiers may be understood as flags used for distinguishing different data transmission tunnels. The first terminal device may perform data transmission to the second terminal device in a manner of sending a data packet. In this case, the data packet sent by the first terminal device carries a connection identifier, and the connection identifier may be the first connection identifier or the second connection identifier described above. A type of a data transmission tunnel through which the data packet is to pass depends on the connection identifier carried in the data packet.

To be specific, when sending a data packet to the second terminal device, the first terminal device predetermines a transmission path corresponding to the data packet, which may be understood as the first data transmission tunnel or the second data transmission tunnel in this embodiment of this disclosure. When the first terminal device determines that the transmission path of the data packet is the first data transmission tunnel, the first connection identifier is allocated to the data packet according to a correspondence between the first data transmission tunnel and the first connection identifier. When the connection identifier carried in the data packet is the first connection identifier, it indicates that the data packet completes data transmission with the second terminal device by using the first data transmission tunnel. When the first terminal device determines that the transmission path of the data packet is the second data transmission tunnel, the second connection identifier is allocated to the data packet according to a correspondence between the second data transmission tunnel and the second connection identifier. When the connection identifier carried in the data packet is the second connection identifier, it indicates that the data packet completes data transmission with the second terminal device by using the second data transmission tunnel. The "first" and the "second" mentioned above are only for the purpose of classifying the terminal devices, the connection identifiers, and the data transmission tunnels, and are not for the purpose of representing meanings such as priorities, importance degrees, and ranks.

S203: Perform data transmission with the second terminal device by using the first data transmission tunnel or the second data transmission tunnel.

S202 completes the requesting to establish a first data transmission tunnel with the transmission gateway according to the first connection identifier, and requesting to establish a second data transmission tunnel with the transmission gateway according to the second connection identifier. To be specific, in the current first network environment, two data transmission tunnels exist between the first terminal device and the second terminal device, and are respectively the first data transmission tunnel and the second data transmission tunnel. When the first terminal device needs to perform data transmission with the second terminal device, the first terminal device may allocate a connection identifier to a data packet. The premise based on which the first terminal device allocates a connection identifier to a data packet is that the first terminal device predetermines a data transmission tunnel of the data packet.

For example, when the first terminal device needs to send a data packet to the second terminal device, if the first terminal device determines that the data packet needs to have data transmitted by using the first data transmission tunnel, the first connection identifier may be allocated to the data packet. When the data packet carries the first connection identifier, the data packet has data transmitted with the second terminal device by using the first data transmission tunnel. If the first terminal device determines that the data packet needs to have data transmitted by using the second data transmission tunnel, the second connection identifier may be allocated to the data packet. When the data packet carries the second connection identifier, the data packet has data transmitted with the second terminal device by using the second data transmission tunnel. In a data transmission tunnel, whether a connection identifier carried in a data packet is the first connection identifier or the second connection identifier may be identified by using a forwarding node, so that the forwarding node determines, according to the identified identifier, the data transmission tunnel of the data packet to forward the data packet to the second terminal device, to complete data transmission between the first terminal device and the second terminal device.

The aforementioned first terminal device requests to establish different data transmission tunnels with the transmission gateway according to different connection identifiers. Different data transmission tunnels are established, so that a data transmission channel between the first terminal device and the second terminal device is no longer a single transmission path. The first data transmission tunnel, the second data transmission tunnel, or another data transmission tunnel may exist. In this way, reliability of data transmission between the first terminal device and the second terminal device can be improved. When a transmission fault occurs in one of the data transmission tunnels, the data transmission tunnel may be switched, so that data transmission between the first terminal device and the second terminal device can be normally performed.

For the first terminal device and the second terminal device that are located in the first network environment, when preparing to connect to the second terminal device, the first terminal device may obtain the first connection identifier and the second connection identifier by initiating a connection request. The first terminal device separately requests to establish the first data transmission tunnel and the second data transmission tunnel with the transmission gateway in the first network environment according to the two connection identifiers. The first terminal device may select, based on a case of the two data transmission tunnels, the first data transmission tunnel or the second data transmission tunnel to send the data packet for the second terminal device, to forward the data packet to the second terminal device in the first network environment by using the transmission gateway. By establishing two independent data transmission tunnels between two terminal devices in a single network environment, even if a transmission problem occurs in one data transmission tunnel, data transmission may be continued by using the other data transmission tunnel, so that an effective fault tolerance basis is provided due to the dual data transmission tunnels, thereby greatly improving the stability of data transmission.

The "requesting to establish a first data transmission tunnel with the transmission gateway according to the first connection identifier, and requesting to establish a second data transmission tunnel with the transmission gateway according to the second connection identifier" is mentioned in S202. To be specific, the current first network environment includes two data transmission tunnels, and one of the data transmission tunnels may be randomly selected to perform data transmission between terminal devices. In this case, a selection manner for two data transmission tunnels needs to be determined. In a possible implementation, a method for "performing data transmission with the second terminal device by using the first data transmission tunnel or the second data transmission tunnel" mentioned in S203 may be specifically: performing, in response to that the first data transmission tunnel is available, data transmission with the second terminal device by using the first data transmission tunnel, a transmitted data packet carrying the first connection identifier; and performing, in response to that the first data transmission tunnel is unavailable, data transmission with the second terminal device by using the second data transmission tunnel, a transmitted data packet carrying the second connection identifier.

Specifically, when the first terminal device needs to perform data transmission with the second terminal device, the first terminal device first needs to determine a data transmission tunnel for data transmission. In this embodiment of this disclosure, when the first terminal device selects a data transmission tunnel, a priority of the first data transmission tunnel may be set to be higher than a priority of the second data transmission tunnel. To be specific, when both the first data transmission tunnel and the second data transmission tunnel exist, the first data transmission tunnel is preferentially selected, and the second data transmission tunnel is selected for data transmission only when the first data transmission tunnel is unavailable.

To be specific, whether the first data transmission tunnel is available needs to be first determined. When it is determined that the first data transmission tunnel is available, the first terminal device may perform data transmission with the second terminal device by using the first data transmission tunnel. When the first terminal device sends a data packet to the second terminal device, the first connection identifier needs to be carried in the data packet.

When it is determined that the first data transmission tunnel is unavailable, the first terminal device may perform data transmission with the second terminal device by using the second data transmission tunnel. When the first terminal device sends a data packet to the second terminal device, the second connection identifier needs to be carried in the data packet.

A reason why the priority of the first data transmission tunnel is set to be relatively high is that the first data transmission tunnel can implement data transmission between terminal devices more efficiently than the second data transmission tunnel.

According to the foregoing provided method for distinguishing priorities of data transmission tunnels, when a plurality of data transmission tunnels exists between terminal devices, use priorities can be set for the plurality of data transmission tunnels according to factors such as an application scenario and data transmission efficiency. By determining the priorities, a data transmission tunnel having a relatively good transmission effect can be preferentially selected in a process of data transmission between terminal devices, so that efficiency of data transmission between the terminal devices can be improved.

The foregoing mentions a method for determining priorities between different data transmission tunnels. After the priorities are determined, when the first terminal device determines a data transmission tunnel for data transmission for a data packet, the first terminal device needs to determine availability of the data transmission tunnel, and determines, according to a determining result of the availability of the data transmission tunnel, whether switching of another data transmission tunnel needs to be performed. Specifically, in a possible implementation, A method for determining availability of a data transmission tunnel may be: first determining that the first data transmission tunnel is available when it is identified that the first data transmission tunnel is successfully established and is not disconnected; and then determining that the first data transmission tunnel is unavailable when it is identified that the first data transmission tunnel is not successfully established, or is successfully established but disconnected.

Specifically, the determining whether the data transmission tunnel is available mainly includes two factors: One factor is determining whether the data transmission tunnel is successfully established, and the other factor is determining, on the premise that the data transmission tunnel is successfully established, whether the data transmission tunnel is disconnected. Only when a data transmission tunnel is successfully established and is not disconnected, it is determined that the data transmission tunnel is available. When a data transmission tunnel is not successfully established, or when a data transmission tunnel is successfully established but is disconnected, it may be considered that the data transmission tunnel is unavailable.

The aforementioned determining availability of a data transmission tunnel is applicable to both the aforementioned first data transmission tunnel and second data transmission tunnel. In actual application, according to different priority orders between the first data transmission tunnel and the second data transmission tunnel, when the first data transmission tunnel has priority over the second data transmission tunnel, availability of the first data transmission tunnel may be first determined. When it is determined that the first data transmission tunnel is unavailable, availability of the second data transmission tunnel is determined. Certainly, the availability of the first data transmission tunnel and the availability of the second data transmission tunnel may also be simultaneously determined, but the determining the availability of the two data transmission tunnels simultaneously may occupy more computational resources within the same period of time than the determining the availability of the data transmission tunnels one by one according to the priorities of the data transmission tunnels. However, this is also a manner capable of determining availability.

By using the aforementioned method for determining availability of a data transmission tunnel, during data transmission between terminal devices, whether a data transmission tunnel between the terminal devices is available can be determined in time, so that the data transmission tunnel can be switched in time according to a determining result, thereby improving data transmission efficiency to some extent.

The foregoing mentions that the data packet carries a connection identifier, for example, the first connection identifier or the second connection identifier. In a possible implementation, the connection identifier may be carried in a connection identifier field in a data packet header of the data packet. To be specific, a data packet header of the data packet includes a connection identifier field, and the connection identifier field carries the first connection identifier or the second connection identifier used for data transmission. The data packet header is a starting part of the data packet, and includes control information of the data packet. Different fields of the data packet header may carry different pieces of control information, and the pieces of control information are crucial to transmission, routing, receiving, and processing of the data packet in a network environment. For example, in this embodiment of this disclosure, the connection identifier field of the data packet header may carry the first connection identifier or the second connection identifier, to indicate how to transmit the data packet in the first network environment.

The connection identifier may be directly, efficiently, accurately, and reliably carried by using the connection identifier field in the data packet header, thereby providing strong support for data transmission. This manner not only improves efficiency and reliability of data transmission, but also simplifies a design and implementation process of a protocol, and reduces development and maintenance costs.

The data transmission method provided in this embodiment of this disclosure may be applied not only to a case in which the first terminal device and the second terminal device are both located in the first network environment, but also to a case in which the first terminal device and the second terminal device are both located in another network environment in addition to the first network environment. In a possible implementation, the first terminal device and the second terminal device are further located in a second network environment, and have a data transmission link in the second network environment.

The second network environment is different from the first network environment. For example, when the first network environment is a network environment of a 5th-generation mobile communication technology, the second network environment may be a Wi-Fi network environment. To be specific, the data transmission method provided in this embodiment of this disclosure may be applied to a case in which terminal devices exist in a plurality of network environments simultaneously. It is mentioned above that the second network environment has a data transmission link, and the data transmission link may be understood as a channel for data transmission between terminal devices. For example, the data transmission link may be an LAN, that is, the terminal devices may perform data transmission between each other by using the LAN.

The aforementioned locating the first terminal device and the second terminal device in the first network environment and the second network environment simultaneously can implement multi-network transmission of data between terminal devices, to extend an application scenario of the data transmission method of this embodiment, and can cover a case of multi-network transmission. In addition, addition of different network environments to perform data transmission can improve selectability of data transmission manners, thereby reducing an error rate of data transmission to some extent.

The aforementioned case in which terminal devices are located in a plurality of network environments simultaneously may be understood as that the terminal devices are located in a multi-network transmission system. A case in which terminal devices are located in a multi-network environment is specifically described by using an example in which terminal devices are located in the first network environment and the second network environment simultaneously.

First, a multi-network transmission system is specifically described. Current application for a multi-network transmission system generally runs on a single network, such as a 5G network or a Wi-Fi network. However, due to problems such as signal fluctuation of a wireless network and terminal mobility switching, a problem of instability of a single wireless network greatly affects a service. For example, instant games (for example, MOBA and RTS games) are very sensitive to a delay, and as the delay increases or jitters, user experience significantly deteriorates; or a live service needs a stable network bandwidth, and if a network has an insufficient capacity or a jittering rate, a video bitrate is reduced or frame freezing is caused.

Therefore, to improve service experience, a problem of unstable or unreliable performance of a single network can be resolved by using multi-network transmission. There are mainly two common multi-network transmission solutions: redundancy transmission and aggregation transmission.

Specifically, redundancy transmission may be understood, for example, as a redundancy function of 5G + Wi-Fi commonly introduced by a game accelerator APP, and has a basic principle as follows: In an uplink direction, an accelerator APP of a terminal device copies a game data packet, and sends the game data packet to a game acceleration gateway by using both 5G and Wi-Fi links. The game acceleration gateway then performs deduplication processing, and sends a correctly received data packet to a game server.

FIG. 3 is a schematic diagram of redundancy transmission according to an embodiment of this disclosure. As shown in FIG. 3, the principle of redundancy transmission is that data packets such as a packet 1 and a packet 2 in the figure are sent on two network links simultaneously, and any data packet can be successfully received after being transmitted correctly, thereby reducing a network delay and jitter, that is, more network resources are consumed to ensure delay performance and reliability of data transmission. However, given that a game service is insensitive to packet loss, an unreliable transmission mode is usually used.

In an aggregation transmission solution, different data packets in the same service are allocated to different networks for transmission according to quality of different network links. FIG. 4 is a schematic diagram of aggregation transmission according to an embodiment of this disclosure. As shown in FIG. 4, for video data of a live stream, a multi-network transmission APP transmits a packet 1 and a packet 3 by using a 5G network, and transmits a packet 2 and a packet 4 by using a Wi-Fi network, and a multi-network transmission gateway performs aggregation processing, recovers to an original service data stream, and then transmits the original service data stream to a final service source station, for example, a live server shown in the figure.

Advantages of aggregation transmission are that capacity of two networks can be fully used, a larger network bandwidth is provided for services, and redundancy data transmission does not exist, thereby saving network traffic. Generally, a reliable transmission mode may be used for an RTMP-type live broadcast based on the Transmission Control Protocol (TCP), and an unreliable transmission mode may be used for an RTC-type live broadcast based on the UDP protocol.

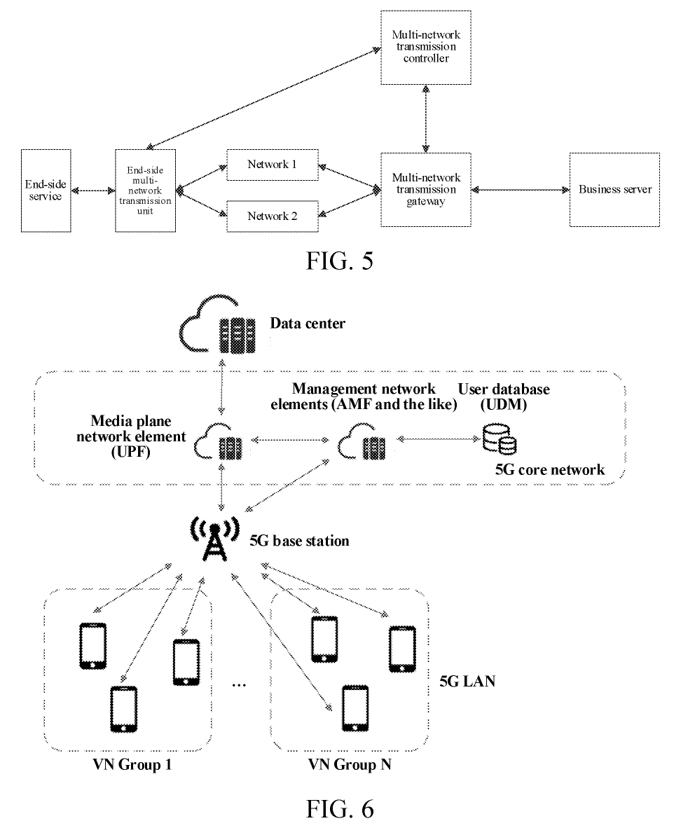

The following describes an architecture of a typical multi-network transmission system. FIG. 5 is a schematic diagram of an architecture of a multi-network transmission system according to an embodiment of this disclosure. As shown in FIG. 5, the multi-network transmission system mainly includes the following three parts: 1, an end-side multi-network transmission unit, which may be a piece of software, such as an SDK or an APP, or may be a hardware terminal device, such as the first terminal device and the second terminal device in the embodiments of this disclosure; 2, a multi-network transmission gateway, which is usually deployed in a cloud in a distributed manner, establishes a data transmission tunnel with the end-side multi-network transmission unit to perform multi-network transmission communication, and forwards data to a final device (that is, the second terminal device in the embodiments of this disclosure); and 3, a multi-network transmission controller, which is generally deployed in the cloud in a centralized manner, performs signaling interaction with the end-side multi-network transmission unit and the multi-network transmission gateway, and is mainly responsible for functions such as configuration management and authentication.

The multi-network transmission system is a standard Client-Server architecture. If two end-side multi-network transmission units need to communicate, transit needs to be performed by using the multi-network transmission gateway. In this embodiment of this disclosure, the end-side multi-network transmission units are equivalent to the first terminal device and the second terminal device.

In this embodiment of this disclosure, when the first terminal device and the second terminal device are located in the first network environment and the second network environment simultaneously, it may be considered that the first terminal device and the second terminal device are located in a multi-network transmission system, and the multi-network transmission system includes: a first data transmission tunnel, a second data transmission tunnel, and a data transmission link. In addition, the multi-network transmission system further includes a multi-network transmission controller. In this case, the first terminal device needs to obtain a connection identifier from the multi-network transmission controller.

The "initiating, in a first network environment, a connection request for a second terminal device to obtain a first connection identifier and a second connection identifier that are used for the first network environment" is mentioned in S201. In a possible implementation, A method for obtaining a connection identifier may be: first sending the connection request for the second terminal device to the multi-network transmission controller in the first network environment; and then obtaining the first connection identifier and the second connection identifier that are used for the first network environment from the multi-network transmission controller.

Specifically, when the first terminal device and the second terminal device are located in the multi-network transmission system simultaneously, in the first network environment, the first terminal device initiates a connection request for the second terminal device, and a sending object of the connection request is the multi-network transmission controller. The first terminal device needs to obtain, from the multi-network transmission controller, the first connection identifier and the second connection identifier that are used in the first network environment, so as to correspondingly establish a data transmission tunnel with the transmission gateway according to the obtained connection identifier.

By using the aforementioned method in which the first terminal device obtains the connection identifier from the multi-network transmission controller, data transmission between the first terminal device and the second terminal device in a scenario of the multi-network transmission system can be implemented. The multi-network transmission controller is responsible for configuration management work of a corresponding connection identifier, to allocate the first connection identifier and the second connection identifier to the first terminal device, so as to establish a data transmission tunnel subsequently.

An embodiment of this disclosure further provides a data transmission method. The method may be performed by a forwarding node. In this embodiment, the aforementioned computer device is the forwarding node.

The method includes:

S301: Determine, when obtaining a data packet sent by a first terminal device to a second terminal device, a to-be-identified connection identifier carried in the data packet.

The first terminal device and the second terminal device are both located in the first network environment. The to-be-identified connection identifier may be understood as a connection identifier that is pre-allocated to or is pre-configured for a data packet according to the determined data transmission tunnel when the first terminal device determines to send the data packet to the second terminal device. When the first terminal device determines that the data transmission tunnel of the data packet is the first data transmission tunnel, the first connection identifier is allocated to the data packet. When the first terminal device determines that the data transmission tunnel of the data packet is the second data transmission tunnel, the second connection identifier is allocated to the data packet. The data packet to which the to-be-identified connection identifier is allocated has data transmitted in the data transmission tunnel corresponding to the to-be-identified connection identifier. In a transmission process of the data packet, when the data packet passes through the forwarding node, the forwarding node identifies the to-be-identified connection identifier, then determines the data transmission tunnel through which the data packet is forwarded to the second terminal device, and then implements data transmission between the first terminal device and the second terminal device.

To be specific, the forwarding node needs to identify and determine the to-be-identified connection identifier carried in the data packet, to determine whether the to-be-identified connection identifier carried in the data packet is the first connection identifier or the second connection identifier.

S302: Forward, in response to that the to-be-identified connection identifier is a first connection identifier in a first connection identifier set, the data packet to the second terminal device by using a target data transmission tunnel.

It is mentioned above that different connection identifiers may correspond to different data transmission tunnels, and then connection identifiers belonging to the same connection identifier set correspond to the same data transmission tunnel. For example, assuming that there are a first connection identifier set and a second connection identifier set, it is mentioned above that the first terminal device requests to establish a first data transmission tunnel with the transmission gateway according to the first connection identifier, and requests to establish a second data transmission tunnel with the transmission gateway according to the second connection identifier. To be specific, the first connection identifier corresponds to the first data transmission tunnel, and the second connection identifier corresponds to the second data transmission tunnel.

Connection identifiers in the first connection identifier set are used for establishing a first data transmission tunnel and a target data transmission tunnel corresponding to the terminal devices, and connection identifiers in the second connection identifier set are used for establishing a second data transmission tunnel and a third data transmission tunnel corresponding to the terminal devices.

When identifying that the to-be-identified connection identifier carried in the data packet is the first connection identifier in the first connection identifier set, the forwarding node may forward the data packet to the second terminal device by using the target data transmission tunnel. The target data transmission tunnel may be understood as a data transmission tunnel established between the second terminal device and the forwarding node by using the first connection identifier. To be specific, data transmission from the forwarding node to the second terminal device may be implemented by using the target data transmission tunnel.

When the second terminal device transmits data to the first terminal device, the second terminal device may determine a data transmission tunnel of a data packet and allocate a data identifier to the data packet according to the determined data transmission tunnel. Data transmission tunnels established between the second terminal device and the transmission gateway are respectively the target data transmission tunnel and the third data transmission tunnel. When the second terminal device determines that the data transmission tunnel of the data packet is the target data transmission tunnel, the first data connection identifier needs to be allocated to the data packet. When the second terminal device determines that the data transmission tunnel of the data packet is the third data transmission tunnel, the second data connection identifier needs to be allocated to the data packet.

When identifying that the to-be-identified connection identifier carried in the data packet is the first connection identifier in the first connection identifier set, the forwarding node may forward the data packet to the first terminal device by using the first data transmission tunnel. To be specific, data transmission from the forwarding node to the first terminal device may be implemented by using the first data transmission tunnel. When identifying that the to-be-identified connection identifier carried in the data packet is the second connection identifier in the second connection identifier set, the forwarding node may forward the data packet from the transmission gateway to the first terminal device by using the second data transmission tunnel.

S303: Forward, in response to that the to-be-identified connection identifier is a second connection identifier in a second connection identifier set, the data packet to a transmission gateway in the first network environment by using a second data transmission tunnel, to cause the transmission gateway to forward the data packet to the second terminal device by using a third data transmission tunnel.

When identifying that the to-be-identified connection identifier carried in the data packet is the second connection identifier in the second connection identifier set, the forwarding node may forward the data packet to the second terminal device by using the third data transmission tunnel. The third data transmission tunnel may be understood as a data transmission tunnel established between the second terminal device and the transmission gateway. To be specific, data transmission between the transmission gateway and the second terminal device may be implemented by using the third data transmission tunnel.

The forwarding node may be understood as a "gate" that is set in the middle of the first data transmission tunnel and the second data transmission tunnel, that is, in data transmission between the first terminal device and the transmission gateway. When the data packet has data transmitted by using the first data transmission tunnel or the second data transmission tunnel, the data packet undergoes "interception" by the forwarding node. The forwarding node identifies the to-be-identified connection identifier in the data packet, and performs different forwarding operations on the data packet according to identification results. The different forwarding operations correspond to different data transmission tunnels. When it is determined that the to-be-identified connection identifier in the data packet is the first connection identifier, the data packet is forwarded to the second terminal device by using the target data transmission tunnel. When it is determined that the to-be-identified connection identifier in the data packet is the second connection identifier, the data packet is forwarded to the second terminal device by using the third data transmission tunnel.

A difference between the target data transmission tunnel and the third data transmission tunnel lies in that a starting point of the target data transmission tunnel is the forwarding node, and a starting point of the third data transmission tunnel is the transmission gateway. It can be seen from here that, when identifying that the to-be-identified connection identifier in the data packet is the first connection identifier, the forwarding node interrupts continued transmission of the data packet from the first terminal device to the transmission gateway, that is, "intercepts" the data packet, and the forwarding node directly forwards the data packet to the second terminal device by using the target data transmission tunnel. When identifying that the to-be-identified connection identifier in the data packet is the second connection identifier, the forwarding node performs continued transmission of the data packet from the first terminal device to the transmission gateway, that is, "releases" the data packet. After the data packet is transmitted to the transmission gateway, the transmission gateway forwards the data packet to the second terminal device by using the third data transmission tunnel.

When the first terminal device establishes the first data transmission tunnel according to the obtained first connection identifier, it is considered by the first terminal device that the established first data transmission tunnel is a data transmission tunnel from the first terminal device to the transmission gateway. However, actually, the first data transmission tunnel established by the first terminal device is a data transmission tunnel from the first terminal device to the second terminal device. Data transmission tunnels from the first terminal device to the second terminal device include the first data transmission tunnel and the target data transmission tunnel. To be specific, the first data transmission tunnel and the target data transmission tunnel are both data transmission tunnels established by the first terminal device by using the first connection identifier. When the data packet sent by the first terminal device has data transmitted by using the first data transmission tunnel, the data packet passes through the forwarding node, and is "intercepted" by the forwarding node and forwarded by using the target data transmission tunnel, to implement data transmission between the first terminal device and the second terminal device.

For example, it is assumed that the first terminal device is a 5G terminal device that expects to perform branch transmission by using the 5G LAN technology but cannot support the 5G LAN technology. When the 5G terminal device establishes the first data transmission tunnel based on the first data identifier, the 5G terminal device considers that the data transmission tunnel is established with the transmission gateway. In this case, regardless of whether the 5G terminal device supports the 5G LAN technology, establishment of the data transmission tunnel (between the terminal device and the transmission gateway) can be completed.

However, actually, the data transmission tunnel established by the 5G terminal device based on the first data identifier is a data transmission tunnel from the 5G terminal device to the second terminal device. In a process of transmitting data by using the first data transmission tunnel, the data passes through a forwarding node in the 5G LAN technology. When the 5G terminal device performs data transmission by using the established data transmission tunnel, the forwarding node "intercepts" a transmitted data packet and determines whether the data packet can support the 5G LAN technology for data transmission. For a data packet that can support the 5G LAN technology for transmission, the data packet is forwarded by using the 5G LAN technology (that is, using the target data transmission tunnel), to forward the data packet to the second terminal device. In this way, the 5G terminal device that expects to perform branch transmission by using the 5G LAN technology but does not support the 5G LAN technology can be implemented, and the 5G LAN technology may also be used to perform branch interconnection by using the forwarding node in the established data transmission tunnel.

It is mentioned in the foregoing description that, when the forwarding node identifies that the to-be-identified connection identifier carried in the data packet is the second connection identifier in the second connection identifier set, the forwarding node "releases" the data packet, so that the data packet can continue to have data transmitted to the transmission gateway by using the second data transmission tunnel. After the data packet reaches the transmission gateway, the transmission gateway needs to perform a further forwarding operation, so that the data packet can be smoothly transmitted to the second terminal device.

The "third data transmission tunnel" mentioned in S303 needs to be used for the aforementioned performing a further forwarding operation by the transmission gateway. The third data transmission tunnel may be understood as a data transmission tunnel established between the transmission gateway and the second terminal device by using the third connection identifier. A data packet can be forwarded from the transmission gateway to the second terminal device by using the third data transmission tunnel, thereby implementing data transmission between the first terminal device and the second terminal device.

The third connection identifier and the second connection identifier both belong to the second connection identifier set. When a data packet is forwarded from the transmission gateway to the second terminal device by using the third data transmission tunnel, the third connection identifier is carried in the data packet. Specifically, when the data packet is located at the transmission gateway, the transmission gateway may determine, by parsing information carried in the data packet, a data transmission tunnel corresponding to a next forwarding operation performed on the data packet. The information carried in the data packet includes information about a data transmission tunnel that data transmission between the first terminal device and the second terminal device correspondingly needs to pass through.

When the transmission gateway determines that a data transmission tunnel corresponding to next forwarding of the data packet is the third data transmission tunnel, the transmission gateway allocates the third connection identifier to the data packet. When the data packet is forwarded to the second terminal device by using the third data transmission tunnel, the third connection identifier is carried in the data packet. The third connection identifier may be used for indicating that the type of the data transmission tunnel through which the data packet is to pass is the third data transmission tunnel.

A data packet can be forwarded from the transmission gateway to the second terminal device by using the aforementioned third data transmission tunnel. The configuring the third connection identifier for the data packet by using the transmission gateway can indicate for the data packet that a data forwarding path is the third data transmission tunnel. In this way, data transmission from the first terminal device to the second terminal device can be implemented.

It is mentioned in the foregoing description that, when the forwarding node identifies that the to-be-identified connection identifier carried in the data packet is the first connection identifier in the first connection identifier set, the forwarding node "intercepts" the data packet, and the forwarding node directly forwards the data packet to the second terminal device by using the target data transmission tunnel, so that the data packet can be smoothly transmitted to the second terminal device. In a process of forwarding the data packet to the second terminal device by using the target data transmission tunnel, switching between a public network address and an intranet address needs to be performed.

The "forwarding the data packet to the second terminal device by using a target data transmission tunnel" is mentioned in S302. In a possible implementation, A method used for data packet forwarding by using the target data transmission tunnel may be: first querying, according to a public network destination address of the second terminal device carried in the data packet, an intranet access address corresponding to the public network destination address; and then replacing the public network destination address in the data packet with the intranet access address to obtain a replaced data packet, and forwarding the replaced data packet to the second terminal device by using the target data transmission tunnel.

The public network destination address mentioned above refers to an address of the second terminal device in an entire network environment, and the intranet access address refers to an address corresponding to access to the second terminal device inside an LAN in which the second terminal device is located. When the forwarding node identifies that the to-be-identified connection identifier carried in the data packet is the first connection identifier, it means that the forwarding node needs to perform data forwarding according to the target data transmission tunnel, that is, a data transmission path needs to be converted from public network data transmission performed to the transmission gateway to intranet transmission directly performed by the forwarding node to the second terminal device. Therefore, the public network destination address of the second terminal device that is carried in the data packet needs to be converted into the corresponding intranet access address, and then the data packet accesses and has data transmitted to the second terminal device by using the target data transmission tunnel.

There is a correspondence between the public network destination address and the intranet access address. The intranet access address of the second terminal device can be determined by using the public network destination address of the second terminal device that is carried in the data packet and the correspondence.

As mentioned above, in the process of forwarding the data packet to the second terminal device by the forwarding node by using the target data transmission tunnel, the public network destination address of the second terminal device that is carried in the data packet is converted into the intranet access address. When the target data transmission tunnel is an intranet data transmission channel, the data packet can access the second terminal device by using the intranet access address obtained through conversion, and data transmission is completed.

As mentioned above, when the connection identifier carried in the data packet is the first connection identifier, and data is transmitted to the transmission gateway by using the first data transmission tunnel, the data packet is "intercepted" by the forwarding node, and the forwarding node forwards the data packet to the second terminal device by using the target data transmission tunnel. In a process of performing forwarding by the forwarding node, the public network destination address of the second terminal device carried in the data packet is converted into an intranet access address. In this case, the data packet carries the intranet access address and the correspondence between the intranet access address and the first connection identifier.

In a possible manner, the correspondence between the first connection identifier and the intranet access address may be stored. The aforementioned correspondence is used for determining a corresponding intranet access address according to the correspondence when a data packet carrying the first connection identifier is obtained next time.

To be specific, when the data packet is forwarded to the second terminal device by using the target data transmission tunnel, the correspondence between the intranet access address of the second terminal device carried in the data packet and the first connection identifier previously carried in the data packet may be stored. Then, next time the forwarding node obtains the data packet carrying the stored first connection identifier, the forwarding node may determine the corresponding intranet access address of the second terminal device according to the previously stored correspondence between the first connection identifier and the intranet access address.

By storing the correspondence between the first connection identifier and the intranet access address, when the data packet carrying the first connection identifier is obtained, the corresponding intranet access address of the second terminal device may be determined according to the correspondence, so that access of the data packet to the second terminal device is directly completed, and data transmission is completed. In this way, repeatedly obtaining the intranet access address of the second terminal device can be avoided, thereby improving the data packet forwarding efficiency.

By using the aforementioned data transmission method performed by the forwarding node, the forwarding node can identify, when obtaining the data packet sent by the first terminal device to the second terminal device, the to-be-identified connection identifier carried in the data packet, and determine a subsequent data transmission tunnel for the data packet according to an identification result, so that the data packet can be successfully forwarded to the second terminal device, thereby completing data transmission between the first terminal device and the second terminal device. The forwarding node can perform "split" processing on the data packet based on different types of to-be-identified connection identifiers. By identifying the to-be-identified connection identifier carried in the data packet, the forwarding node can determine a subsequent data transmission tunnel of the data packet, and can implement branch transmission in the same network environment, so that one of the data transmission tunnels between the first terminal device and the second terminal device can be selected and cited according to different connection identifiers.

It is mentioned above that the first terminal device and the second terminal device are both located in the first network environment. In a possible implementation, in this embodiment of this disclosure, the first network environment may be determined as a 5G environment, and the first data transmission tunnel may be determined as a 5G LAN tunnel. In this case, the priority of the first data transmission tunnel is set to be higher than that of the second data transmission tunnel. To be specific, when data is transmitted between the first terminal device and the second terminal device, the 5G LAN tunnel may be preferentially selected and used. The reason is that the 5G LAN tunnel can be used to implement branch interconnection between terminal devices for data transmission.

To be specific, when the first terminal device obtains the first connection identifier used in the first network environment (the 5G environment), the corresponding first data transmission tunnel is a 5G LAN tunnel. To be specific, the 5G LAN is used to implement data transmission between the first terminal device and the second terminal device.

Next, the 5G LAN technology is specifically described. The 5G LAN is to "group" or "place in a group" terminals to form an LAN network by using the 5G technology. FIG. 6 is a diagram of an architecture of a 5G LAN according to an embodiment of this disclosure. As shown in FIG. 6, in a 5G network, an administrator may modify data in a user database (Unified Data Management (UDM) function) and perform service subscription for specified terminal (UE) numbers, to place the numbers in the same virtual network (VN) group or different VN groups. A data center provides VN group information (for example, VN Group 1 and VN Group N in the figure) and access policies of the terminal numbers to management network elements (for example, a Session Management Function (SMF), an Access and Mobility Management Function (AMF), and a Policy Control Function (PCF)) of a 5G core network (5GC). The management network elements combine the information and the policy rules into different LANs. This is a 5G LAN. On a network side, the 5G LAN system may include a 5G LAN controller (usually implemented by the AMF) and a 5G LAN forwarding unit (usually implemented by a user plane function (UPF)). For data exchange between the 5G LAN and the 5G core network, a connection needs to be established by using a 5G base station.

FIG. 7 is a schematic diagram of a structure of a 5G LAN according to an embodiment of this disclosure. As shown in FIG. 7, the 5G LAN supports direct access to each other by using Layer 2 communication under the same network segment, thereby implementing local networking, which can help users such as an enterprise, a school, and a family to better interconnect terminal devices within an area, for example, connect to a remote branch organization as a supplement to a conventional private line network of an enterprise.

Currently, there is a problem that a 5G terminal device expects to perform branch transmission by using the 5G LAN technology, but the 5G terminal device cannot support the 5G LAN technology. In this embodiment of this disclosure, A solution to the foregoing problem is: A data transmission tunnel is established for the 5G terminal device, and the 5G terminal device considers that the data transmission tunnel is established with the transmission gateway. In this case, regardless of whether the 5G terminal device supports the 5G LAN technology, establishment of the data transmission tunnel (between the terminal device and the transmission gateway) can be completed. However, actually, all established data transmission tunnels pass through a forwarding node in the 5G LAN technology, and when the 5G terminal device performs data transmission by using the established data transmission tunnel, the forwarding node "intercepts" a transmitted data packet and determines whether the data packet can support the 5G LAN technology for data transmission. For a data packet that can support the 5G LAN technology, the data packet is forwarded by using the 5G LAN technology. In this way, the 5G terminal device that expects to perform branch transmission by using the 5G LAN technology but does not support the 5G LAN technology can be implemented, and the 5G LAN technology may also be used to perform branch interconnection by using the forwarding node in the established data transmission tunnel.

Based on the above description, the first network environment is set to the 5G network environment, and the first data transmission tunnel is set to the 5G LAN tunnel. A 5G terminal device that is expected to perform branch transmission by using the 5G LAN technology but cannot support the 5G LAN technology may "intercept" and forward a data packet by using a forwarding node in the 5G LAN technology in a data transmission tunnel, to perform branch interconnection with another terminal device by using the 5G LAN technology.

It is mentioned above that the connection identifier is carried in the data packet. In a possible implementation, the connection identifier may be carried in a connection identifier field in a data packet header of the data packet. To be specific, a data packet header of the data packet includes a connection identifier field, and the connection identifier field carries the first connection identifier or the second connection identifier used for data transmission.

In addition, in a possible implementation, the first data transmission tunnel and the second data transmission tunnel may be established according to an MP-QUIC protocol. In this case, the aforementioned data packet sent by the first terminal device to the second terminal device is a QUIC data packet. The QUIC data packet header of the aforementioned QUIC data packet includes a connection identifier field, and the connection identifier field carries the first connection identifier or the second connection identifier used for data transmission.

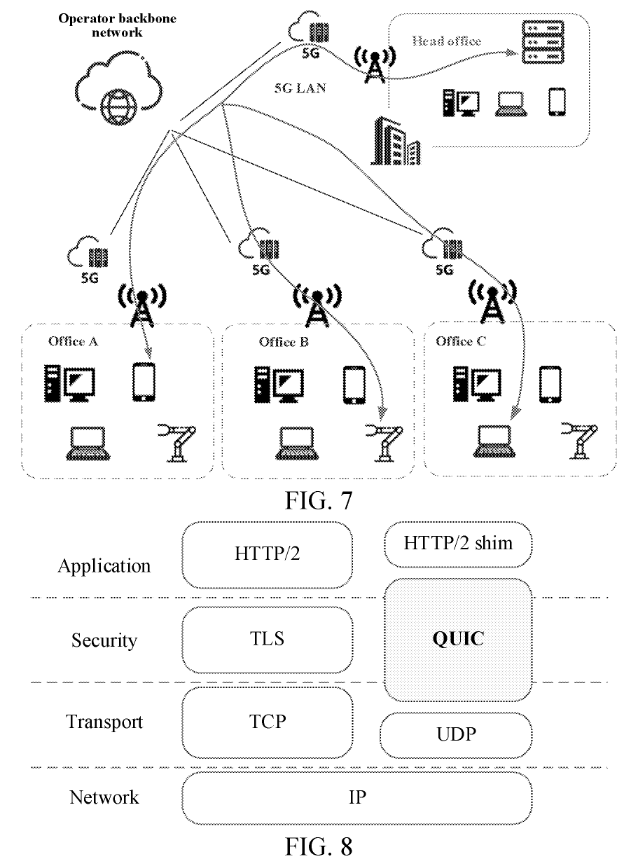

The following describes the aforementioned MP-QUIC in detail. The MP-QUIC protocol has basic functions such as packet encapsulation, packet loss recovery, buffer management, and multi-path management. The MP-QUIC is a multi-path version of the single-path QUIC. The QUIC is mainly intended to resolve some problems encountered by the TCP protocol in an actual use process, such as head-of-line blocking, low congestion control efficiency, disconnection caused by an IP/PORT change, overheads of 3-way handshake, and low out-of-band control efficiency. Therefore, to resolve the foregoing some pain point problems on transmission based on the TCP, a new transmission protocol based on the UDP is designed, and is referred to as QUIC. In conclusion, the QUIC may be basically considered as a transmission protocol replacing the TCP protocol; and is based on the UDP, and usually runs in a user mode. Advantages of QUIC are as follows: 1RTT connection establishment (0RTT directly sends a packet when there is a PSK buffer); a flexible congestion control mechanism, where a congestion control algorithm may be freely customized; multiplexing, to alleviate a head-of-line blocking symptom; supporting connection migration; and having performance better than that of the TCP. The Multipath QUIC is an extension of the QUIC, and the MP-QUIC is designed with the following several considerations: (1) The original QUIC as much as possible is reused, for example, a path validation mechanism and a connection migration mechanism of the QUIC are reused; (2) a packet header the same as that of the QUIC is completely used; (3) congestion control, round-trip time (RTT) measurement, and Path Maximum Transmission Unit (PMTU) detection are implemented based on each physical link; and (4) a path is uniquely identified by an IP quadruple. FIG. 8 is a schematic diagram of a QUIC protocol stack according to an embodiment of this disclosure. As shown in FIG. 8, the diagram includes: an application layer, a security architecture, a transport layer, and a network layer. The application layer includes the HTTP/2 protocol and the QUIC protocol; the security architecture includes the Transport Layer Security (TLS) protocol and the QUIC protocol; the transport layer includes the TCP protocol, the UDP protocol, and the QUIC protocol; and the network layer includes the IP protocol. The QUIC replaces most conventional HTTPS protocol stacks: Hypertext Transfer Protocol version 2 (HTTP/2), Transport Layer Security (TLS), and TCP.

Generally, the QUIC protocol provides a secure and multiplexed connection for transmitting a reliable flow of application data, and the reliable application data is sent by using a STREAM frame. However, some applications, especially those applications that need to transmit real-time data, are more suitable for unreliable data transmission. Therefore, correspondingly, the QUIC extension supports unreliable data transmission, that is, newly defines a Datagram frame type. Transmission of unreliable data by using QUIC has the following advantages: (1) Handshake and authentication may be shared between a reliable QUIC stream and an unreliable QUIC data packet, and in this way, a handshake delay can be reduced compared with using a TLS/Datagram Transport Layer Security (DTLS) connection; (2) the QUIC uses a packet loss recovery mechanism that is more elaborate than the DTLS handshake, so that packet loss recovery of QUIC data is faster; (3) the QUIC data packet is unreliable, but can support acknowledgment, so that an application can know whether the data packet is successfully received; and (4) the QUIC has a congestion control mechanism. These features are very useful for optimizing game applications and other real-time applications (for example, RTC audio/video streaming applications).

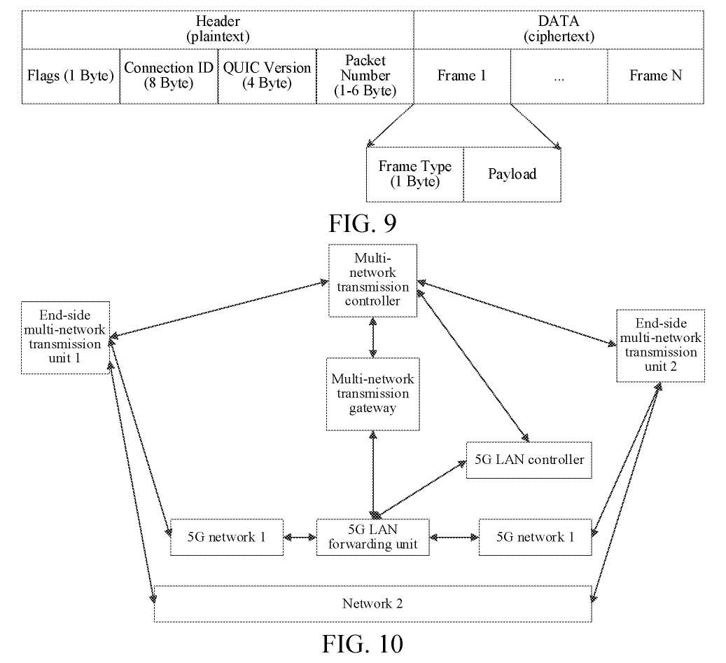

A format of a QUIC data packet includes two parts: header and data. FIG. 9 is a schematic diagram of a structure of a QUIC data packet format according to an embodiment of this disclosure. As shown in FIG. 9, the Header is a plaintext and includes 4 fields: Flags, Connection ID, QUIC Version, and Packet Number. The Data is encrypted and may include one or more frames. Each frame is further divided into a type and a payload. The payload is application data.

In this case, when the data packet is a QUIC data packet, the connection identifier field may be a Connection ID, that is, a CID, in a QUIC data packet header (that is, Header) of the QUIC data packet. CID may be divided into a CID1 set (that is, a first connection identifier set) and a CID2 set (that is, a second connection identifier set). In this case, the first data transmission tunnel with the transmission gateway may be requested to be established according to a CID (that is, the first connection identifier) in the CID1 set, and the second data transmission tunnel with the transmission gateway may be requested to be established according to a CID (that is, the second connection identifier) in the CID2 set. When the first data transmission tunnel is a 5G LAN tunnel, it means that when the data packet carries a CID (the first connection identifier) in the CID1 set, the data packet has data transmitted by using the 5G LAN tunnel.

The set division is performed on the original CID field in the QUIC data packet, and the CID field is allocated to the data packet, so that the data transmission tunnel for transmitting the data packet can be determined. When terminal devices intend to implement branch interconnection for the data packet by using the 5G LAN technology, if the first data transmission tunnel is set to the 5G LAN tunnel, provided that the CID field in the data packet is modified to a CID (that is, the first connection identifier) in the CID1 set, 5G LAN branch interconnection between the terminal devices can be implemented at low modification costs.

An embodiment of this disclosure further provides a data transmission method in a multi-network scenario. FIG. 10 is a schematic diagram of a data transmission method in a multi-network scenario according to an embodiment of this disclosure. As shown in FIG. 10, in this scenario, an end-side multi-network transmission unit 1 and an end-side multi-network transmission unit 2 are located in network environments of a 5G network 1 and a network 2 simultaneously. As described above for the multi-network transmission system, the multi-network transmission system includes a multi-network transmission controller and an end-side multi-network transmission unit, that is, a multi-network transmission gateway.

In the multi-network transmission system in the multi-network scenario, the multi-network transmission controller needs to allocate a connection identifier to an end-side multi-network transmission unit. Specifically, the multi-network transmission controller divides CID fields in the QUIC. A CID1 set (assuming that there are a total of 20000 CID fields, ranging from 0 to 19999, 0 to 9999) is used for end-to-end branch interconnection communication, and a CID2 set (for example, 10000 to 19999) is used for conventional terminal-gateway communication. In this embodiment of this disclosure, the CID1 set is the first connection identifier set mentioned above, the CID2 set is the second connection identifier set mentioned above, the end-side multi-network transmission unit 1 is equivalent to the first terminal device mentioned above, and the end-side multi-network transmission unit 2 is equivalent to the second terminal device mentioned above.

When needing to perform data transmission with the end-side multi-network transmission unit 2, the end-side multi-network transmission unit 1 first notifies the multi-network transmission controller that the end-side multi-network transmission unit 1 needs to perform end-to-end branch interconnection communication with the end-side multi-network transmission unit 2. In response to a request of the end-side multi-network transmission unit, the multi-network transmission controller randomly selects a CID value from each of the CID1 set and the CID2 set, and the values are respectively marked as N1 (a first connection identifier) and M1 (a second connection identifier), and allocated to the end-side transmission unit 1 for use; and randomly selects a CID value from the CID2 set, and the value is marked as M2, and is allocated to the end-side multi-network transmission unit 2 for use.

The multi-network transmission controller transmits information about the CID1 set and the CID2 set to a 5G LAN controller.

The multi-network transmission controller instructs the end-side multi-network transmission unit 1 to establish a QUIC tunnel with a CID = M1 with the multi-network transmission gateway; instructs the end-side multi-network transmission unit 2 to establish a QUIC tunnel with a CID = M2 with the multi-network transmission gateway; and instructs the end-side multi-network transmission unit 1 to establish a QUIC tunnel with a CID = N1 with the end-side multi-network transmission unit 2. The multi-network transmission controller notifies the end-side multi-network transmission unit 1 of a public network IP and a public network port number of the end-side multi-network transmission unit 2, and vice versa. The foregoing three established QUIC tunnels all need to pass through a 5G LAN forwarding unit.

When the end-side multi-network transmission unit 1 sends a data packet to the 5G LAN forwarding unit by using the 5G network 1, the 5G LAN forwarding unit intercepts the data packet, and determines, according to the information about the CID1 set and the CID2 set recorded in the 5G LAN controller, a set to which a connection identifier carried in the data packet belongs.

If it is identified that the data packet is a QUIC data packet whose carried CID belongs to the CID2 set (the CID is transmitted in plaintext), after normally passing through the multi-network transmission gateway, the data packet is forwarded to the end-side multi-network transmission unit 2 by using a QUIC tunnel with a CID = M2. If it is identified that the data packet is a QUIC data packet whose carried CID belongs to the CID1 set, the 5G LAN forwarding unit backward learns an intranet IP and an intranet port number that correspond to a destination public network IP and a destination public network port number, replaces the destination public network IP and the destination public network port number with an intranet IP and an intranet port number of the end-side multi-network transmission unit 2, and then forwards the data packet by using the 5G LAN technology. In addition, the 5G LAN forwarding unit records an intranet IP and an intranet port number that correspond to the CID, to avoid repeated query next time.

As mentioned above, the end-side multi-network transmission unit 1 establishes a QUIC tunnel with a CID = M1 with the multi-network transmission gateway (that is, the foregoing second data transmission tunnel); the end-side multi-network transmission unit 2 establishes a QUIC tunnel with a CID = M2 with the multi-network transmission gateway (that is, the foregoing third data transmission tunnel); and the end-side multi-network transmission unit 1 establishes a QUIC tunnel with a CID = N1 with the end-side multi-network transmission unit 2 (that is, the foregoing first data transmission tunnel (until the 5G LAN forwarding unit) + a target data transmission tunnel). When it is determined that the QUIC tunnel with a CID = N1 between the end-side multi-network transmission unit 1 and the end-side multi-network transmission unit 2 is successfully established, the QUIC tunnel with a CID = N1 is preferably selected and used for data transmission between the end-side multi-network transmission unit 1 and the end-side multi-network transmission unit 2.

If the QUIC tunnel with a CID = N1 between the end-side multi-network transmission unit 1 and the end-side multi-network transmission unit 2 is unsuccessfully established, or is subject to link interruption, the end-side multi-network transmission unit 1 performs transmission by using the QUIC tunnel with a CID = M1. Transmission is performed by using the QUIC tunnel with a CID = M1. When the data packet passes through the 5G LAN forwarding unit, the 5G LAN forwarding unit intercepts the data packet, and determines, according to the information about the CID1 set and the CID2 set recorded in the 5G LAN controller, a set to which a connection identifier carried in the data packet belongs. When it is determined that the connection identifier carried in the data packet belongs to the CID2 set, the data packet is "released", so that the data packet continues to have data transmitted on the QUIC tunnel with a CID = M1. After receiving the data, the multi-network transmission gateway transmits the data to the end-side multi-network transmission unit 2 by using the QUIC tunnel with a CID = M2. A process in which the end-side multi-network transmission unit 2 transmits data to the end-side multi-network transmission unit 1 is similar to that described above, and details are not described herein again.

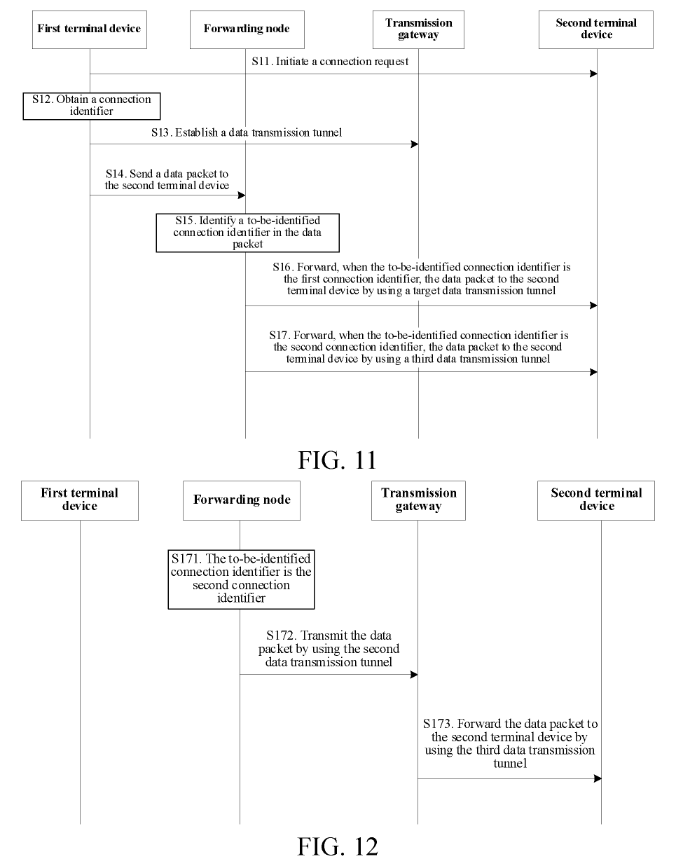

In a possible implementation, FIG. 11 is a signaling diagram of a data transmission method according to an embodiment of this disclosure. As shown in the figure, the method specifically includes:

S11: Initiate a connection request.

When a first terminal device and a second terminal device are located in a first network environment simultaneously, if the first terminal device needs to transmit data to the second terminal device, the first terminal device first needs to initiate a connection request to the second terminal device.

S12: Obtain a connection identifier.

After initiating a request to the second terminal device, the first terminal device needs to obtain a first connection identifier and a second connection identifier that are used for the first network environment.

S13: Establish a data transmission tunnel.

After obtaining the first connection identifier and the second connection identifier, the first terminal device needs to establish a data transmission tunnel with a transmission gateway according to the foregoing two data connection identifiers. Specifically, a request is made to establish a first data transmission tunnel with the transmission gateway according to the first connection identifier, and a request is made to establish a second data transmission tunnel with the transmission gateway according to the second connection identifier.

S14: Send a data packet to the second terminal device.

After completing establishment of the data transmission tunnel, the first terminal device sends the data packet to the second terminal device.

S15: Identify a to-be-identified connection identifier in the data packet.

In a process in which the first terminal device transmits the data packet to the second terminal device by using the first data transmission tunnel or the second data transmission tunnel, the data packet passes through a forwarding node. In this case, the forwarding node identifies the to-be-identified connection identifier carried in the data packet.

S16: Forward, when the to-be-identified connection identifier is the first connection identifier, the data packet to the second terminal device by using a target data transmission tunnel.

When identifying that the to-be-identified connection identifier carried in the data packet is the first connection identifier in the first connection identifier set, the forwarding node forwards the data packet to the second terminal device by using the target data transmission tunnel.

S17: Forward, when the to-be-identified connection identifier is the second connection identifier, the data packet to the second terminal device by using a third data transmission tunnel.

FIG. 12 is a signaling diagram of a data transmission method according to an embodiment of this disclosure. As shown in the figure, a specific implementation method of the aforementioned S17 is:

S171: The to-be-identified connection identifier is the second connection identifier.

The forwarding node identifies the to-be-identified connection identifier carried in the data packet, and identifies the to-be-identified connection identifier as the second connection identifier.

S172: Transmit the data packet by using the second data transmission tunnel.

When determining that the to-be-identified identifier is the second connection identifier, the forwarding node transmits data of the data packet to the transmission gateway by using the second data transmission tunnel.

S173: Forward the data packet to the second terminal device by using the third data transmission tunnel.

After the transmission gateway receives the data packet, the transmission gateway forwards the data packet to the second terminal device by using the third data transmission tunnel.

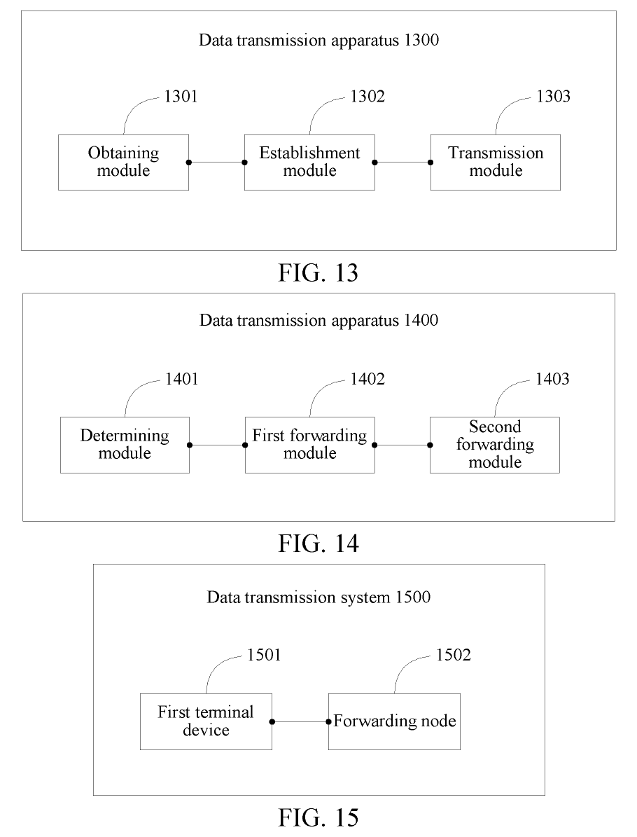

Based on the embodiments corresponding to FIG. 1 to FIG. 12, FIG. 13 is a schematic apparatus diagram of a data transmission apparatus according to an embodiment of this disclosure. The apparatus is applied to a first terminal device, and the data transmission apparatus 1300 includes: an obtaining module 1301, an establishment module 1302, and a transmission module 1303.

The obtaining module is configured to initiate, in a first network environment, a connection request for a second terminal device to obtain a first connection identifier and a second connection identifier that are used for the first network environment, the first terminal device and the second terminal device being located in the first network environment, and the first network environment including a transmission gateway used for data packet forwarding;

the establishment module is configured to request to establish a first data transmission tunnel with the transmission gateway according to the first connection identifier, and request to establish a second data transmission tunnel with the transmission gateway according to the second connection identifier; and

the transmission module is configured to perform data transmission with the second terminal device by using the first data transmission tunnel or the second data transmission tunnel.

In a possible implementation, the transmission module is configured to:

perform, in response to that the first data transmission tunnel is available, data transmission with the second terminal device by using the first data transmission tunnel, a transmitted data packet carrying the first connection identifier; and

perform, in response to that the first data transmission tunnel is unavailable, data transmission with the second terminal device by using the second data transmission tunnel, a transmitted data packet carrying the second connection identifier.

In a possible implementation, the apparatus is configured to:

determine that the first data transmission tunnel is available when it is identified that the first data transmission tunnel is successfully established and is not disconnected; and

determine that the first data transmission tunnel is unavailable when it is identified that the first data transmission tunnel is not successfully established, or is successfully established but disconnected.

In a possible implementation,

the first terminal device and the second terminal device are further located in a second network environment, and have a data transmission link in the second network environment.

In a possible implementation, for the first terminal device and the second terminal device, a multi-network transmission system formed based on the first data transmission tunnel, the second data transmission tunnel, and the data transmission link includes a multi-network transmission controller, and the obtaining module is configured to:

send the connection request for the second terminal device to the multi-network transmission controller in the first network environment; and

obtain the first connection identifier and the second connection identifier that are used for the first network environment from the multi-network transmission controller.

In a possible implementation,

a data packet header of the data packet includes a connection identifier field, where the connection identifier field carries the first connection identifier or the second connection identifier used for data transmission.

In a possible implementation,

the first data transmission tunnel and the second data transmission tunnel are established according to an MP-QUIC protocol, and the data packet is a QUIC data packet.

In a possible implementation,

the first network environment is a 5th-generation mobile communication technology (5G) network environment, and the first data transmission tunnel is a 5G LAN tunnel.

According to the data transmission apparatus provided above, for the first terminal device and the second terminal device that are located in the first network environment, when preparing to connect to the second terminal device, the first terminal device may obtain the first connection identifier and the second connection identifier by initiating a connection request. The first terminal device separately requests to establish the first data transmission tunnel and the second data transmission tunnel with the transmission gateway in the first network environment according to the two connection identifiers. The first terminal device may select, based on a case of the two data transmission tunnels, the first data transmission tunnel or the second data transmission tunnel to send the data packet for the second terminal device, to forward the data packet to the second terminal device in the first network environment by using the transmission gateway. By establishing two independent data transmission tunnels between two terminal devices in a single network environment, even if a transmission problem occurs in one data transmission tunnel, data transmission may be continued by using the other data transmission tunnel, so that an effective fault tolerance basis is provided due to the dual data transmission tunnels, thereby greatly improving the stability of data transmission.

FIG. 14 is a schematic apparatus diagram of another data transmission apparatus according to an embodiment of this disclosure. The apparatus is applied to a forwarding node in a first network environment, and the data transmission apparatus 1400 includes: a determining module 1401, a first forwarding module 1402, and a second forwarding module 1403.

The determining module is configured to determine, when obtaining a data packet sent by a first terminal device to a second terminal device, a to-be-identified connection identifier carried in the data packet, the first terminal device and the second terminal device being located in the first network environment;

the first forwarding module is configured to forward, in response to that the to-be-identified connection identifier is a first connection identifier in a first connection identifier set, the data packet to the second terminal device by using a target data transmission tunnel, the target data transmission tunnel being a data transmission tunnel established between the second terminal device and the forwarding node by using the first connection identifier; and

the second forwarding module is configured to forward, in response to that the to-be-identified connection identifier is a second connection identifier in a second connection identifier set, the data packet to a transmission gateway in the first network environment by using a second data transmission tunnel, to cause the transmission gateway to forward the data packet to the second terminal device by using a third data transmission tunnel.

In a possible implementation,

the third data transmission tunnel is a data transmission tunnel established between the second terminal device and the transmission gateway by using a third connection identifier, and the third connection identifier belongs to the second connection identifier set; and

when the data packet is forwarded to the second terminal device by using the third data transmission tunnel, the connection identifier carried in the data packet is the third connection identifier.

In a possible implementation, the first forwarding module is configured to:

query, according to a public network destination address of the second terminal device carried in the data packet, an intranet access address corresponding to the public network destination address; and

replace the public network destination address in the data packet with the intranet access address to obtain a replaced data packet, and forward the replaced data packet to the second terminal device by using the target data transmission tunnel.

In a possible implementation, the apparatus is configured to:

store a correspondence between the first connection identifier and the intranet access address, the correspondence being used for determining a corresponding intranet access address according to the correspondence when a data packet carrying the first connection identifier is obtained next time.

According to the data transmission apparatus provided above, for the first terminal device and the second terminal device that are located in the first network environment, when the first terminal device performs data transmission with the second terminal device by using the first or second data transmission tunnel, and when obtaining the data packet sent by the first terminal device to the second terminal device, the forwarding node in the first network environment identifies the to-be-identified connection identifier in the data packet, and then determines, according to an identification result, whether the data transmission tunnel forwarding the data packet is the third data transmission tunnel or the target data transmission tunnel. In this way, by using the forwarding unit, data transmission tunnels can be "split" for data packets carrying different to-be-identified connection identifiers, so as to complete data transmission between the first terminal device and the second terminal device.

An embodiment of this disclosure further provides a data transmission system. FIG. 15 is a schematic diagram of a structure of a data transmission system according to an embodiment of this disclosure. As shown in FIG. 15, the data transmission system 1500 includes: a first terminal device 1501 and a forwarding node 1502. The first terminal device is configured to perform the operations performed by the first terminal device in the foregoing embodiments, and the forwarding node is configured to perform the operations performed by the forwarding node in the foregoing embodiments.

Embodiments of this disclosure further provide a computer device. The computer device is the foregoing computer device, and may include a terminal device or a server. The foregoing data transmission apparatus may be configured in the computer device. The following describes the computer device with reference to the accompanying drawings.

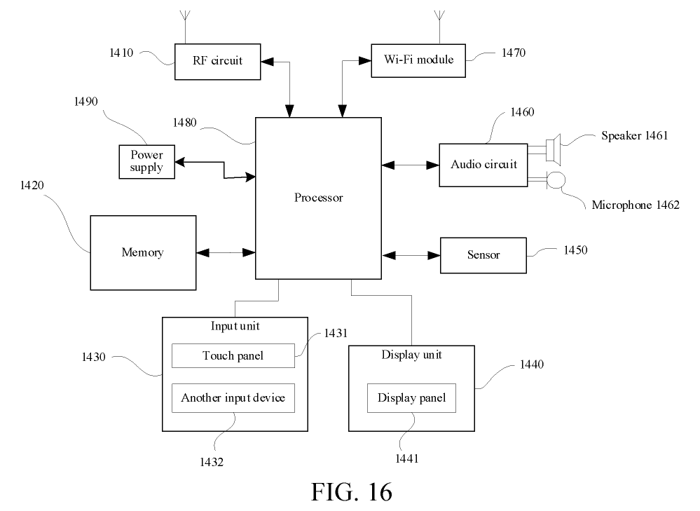

If the computer device is a terminal device, refer to FIG. 16. Embodiments of this disclosure provide a terminal device. An example in which the terminal device is a mobile phone is used:

FIG. 16 is a block diagram of a partial structure of a mobile phone related to the terminal device provided in this embodiment of this disclosure. Referring to FIG. 16, the mobile phone includes: a radio frequency (RF) circuit 1410, a memory 1420, an input unit 1430, a display unit 1440, a sensor 1450, an audio circuit 1460, a Wi-Fi module 1470, a processor 1480, a power supply 1490, and other components. A person skilled in the art may understand that the structure of the mobile phone shown in FIG. 16 does not constitute a limitation on the mobile phone. The mobile phone may include more or fewer components than those shown in the figure, or may combine some components, or may have different component arrangements.

The following specifically describes the components of the mobile phone with reference to FIG. 16.

The RF circuit 1410 may receive and send a signal during an information receiving and sending process or a conversation process, specifically, receives downlink information from a base station, then delivers the downlink information to the processor 1480 for processing, and sends related uplink data to the base station.

The memory 1420 may be configured to store a software program and a module. The processor 1480 runs the software program and the module that are stored in the memory 1420, to perform various functional applications and data processing of the mobile phone. The memory 1420 may mainly include a program storage region and a data storage region. The program storage region may store an operating system, an application required by at least one function (for example, a sound playback function and an image display function), and the like. The data storage region may store data (for example, audio data and an address book) created according to the use of the mobile phone, and the like. In addition, the memory 1420 may include a high-speed random-access memory, and may also include a non-volatile memory, such as at least one magnetic disk storage device, a flash memory, or another volatile solid-state memory.

The input unit 1430 may be configured to receive input digit or character information, and generate a keyboard signal input related to user settings and function control of the mobile phone. Specifically, the input unit 1430 may include a touch panel 1431 and another input device 1432.

The display unit 1440 may be configured to display information inputted by a user or information provided for the user, and various menus of the mobile phone. The display unit 1440 may include a display panel 1441.

The mobile phone may further include at least one sensor 1450 such as an optical sensor, a motion sensor, and other sensors.

The audio circuit 1460, a speaker 1461, and a microphone 1462 may provide audio interfaces between the user and the mobile phone.

Wi-Fi is a short-distance wireless transmission technology. The mobile phone may help, by using the Wi-Fi module 1470, the user to transmit an email, browse a web page, access stream media, and the like, to allow wireless broadband Internet access of the user.

The processor 1480 is a control center of the mobile phone, and is connected to various parts of the entire mobile phone via various interfaces and lines. Various functions of the mobile phone and data processing are performed by running or executing the software program and/or the module stored in the memory 1420 and invoking data stored in the memory 1420.

The mobile phone further includes the power supply 1490 (for example, a battery) for supplying power to the components.

In this embodiment, the processor 1480 included in the terminal device further has the following functions:

initiating, in a first network environment, a connection request for a second terminal device to obtain a first connection identifier and a second connection identifier that are used for the first network environment, the first terminal device and the second terminal device being located in the first network environment, and the first network environment including a transmission gateway used for data packet forwarding;

requesting to establish a first data transmission tunnel with the transmission gateway according to the first connection identifier, and requesting to establish a second data transmission tunnel with the transmission gateway according to the second connection identifier; and

performing data transmission with the second terminal device by using the first data transmission tunnel or the second data transmission tunnel.

Alternatively, the processor 1480 further has the following functions:

determining, when obtaining a data packet sent by a first terminal device to a second terminal device, a to-be-identified connection identifier carried in the data packet, the first terminal device and the second terminal device being located in the first network environment;

forwarding, in response to that the to-be-identified connection identifier is a first connection identifier in a first connection identifier set, the data packet to the second terminal device by using a target data transmission tunnel, the target data transmission tunnel being a data transmission tunnel established between the second terminal device and the forwarding node by using the first connection identifier; and

forwarding, in response to that the to-be-identified connection identifier is a second connection identifier in a second connection identifier set, the data packet to a transmission gateway in the first network environment by using a second data transmission tunnel, to cause the transmission gateway to forward the data packet to the second terminal device by using a third data transmission tunnel.

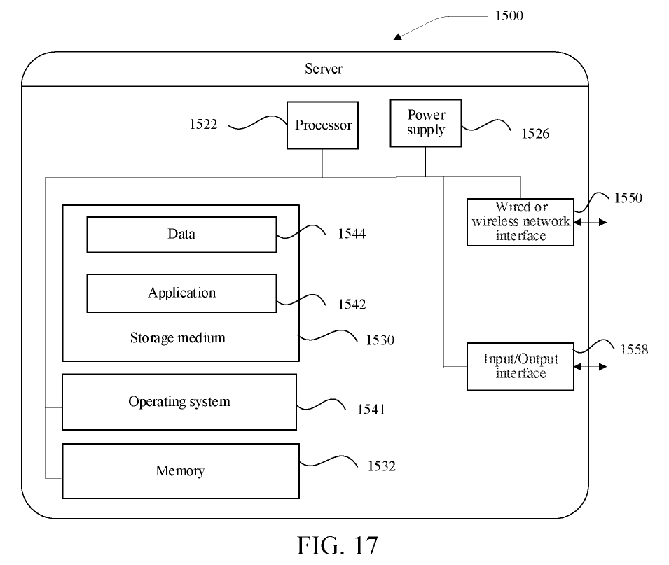

If the computer device is a server, embodiments of this disclosure further provide a server. Refer to FIG. 17. FIG. 17 is a structural diagram of a server 1500 according to an embodiment of this disclosure. The server 1500 greatly differs due to different configurations or performances. The server may include one or more central processing units (CPU) 1522 (for example, one or more processors), a memory 1532, and one or more storage media 1530 (for example, one or more mass storage devices) for storing applications 1542 or data 1544. The memory 1532 and the storage medium 1530 may be configured for temporary storage or persistent storage. A program stored in the storage medium 1530 may include one or more modules (not shown). Each module may include a series of instruction operations on the server. In addition, the CPU 1522 may be configured to communicate with the storage medium 1530, and perform, on the server 1500, the series of instruction operations in the storage medium 1530.

The server 1500 may further include one or more power supplies 1526, one or more wired or wireless network interfaces 1550, one or more input/output interfaces 1558, and/or one or more operating systems 1541 such as Windows Server^{TM}, Mac OS X^{TM}, Unix^{TM}, Linux^{TM}, or FreeBSD^{TM}.

Operations performed by the server in the foregoing embodiment may be based on the structure of the server shown in FIG. 17.

In addition, the embodiments of this disclosure further provide a non-transitory storage medium. The non-transitory storage medium is configured to store a computer program. The computer program is configured to perform the method provided in the foregoing embodiments.

Embodiments of this disclosure further provide a computer program product including a computer program. The computer program, when run on a computer device, causes the computer device to perform the method provided in the foregoing embodiments.

A person of ordinary skill in the art may understand that all or some of the operations of the method embodiments may be implemented by a program instructing relevant hardware. The program may be stored in a non-transitory computer-readable storage medium. When the program runs, the operations of the method embodiments are performed. The foregoing non-transitory storage medium may be at least one of the following media: any medium that can store a computer program, such as a read-only memory (ROM), a random-access memory (RAM), a magnetic disk, or an optical disc.

In embodiments of this disclosure, the term "module" or "unit" refers to a computer program having a predetermined function or a part of a computer program, and works together with other related parts to achieve a predetermined objective, and may be all or partially implemented by using software, hardware (for example, a processing circuit or a memory), or a combination thereof. Similarly, one processor (or a plurality of processors or memories) may be used to implement one or more modules or units. In addition, each module or unit may be a part of an integral module or unit including a function of the module or unit.

The embodiments in this specification are all described in a progressive manner, for same or similar parts in the embodiments, reference may be made to these embodiments, and each embodiment focuses on a difference from other embodiments. Especially, device and system embodiments are basically similar to the method embodiments, and therefore are described briefly. For related parts, refer to partial descriptions in the method embodiments. The described device and system embodiments are merely exemplary. The units described as separate parts may or may not be physically separated, and parts displayed as units may or may not be physical units, may be located in one position, or may be distributed on a plurality of network units. Some or all of the modules may be selected according to actual needs to achieve the objectives of the solutions of this embodiment. A person of ordinary skill in the art may understand and implement the embodiments without creative efforts.

The foregoing is merely a specific implementation of this application, but is not intended to limit the protection scope of this application. Any variation or replacement readily figured out by a person skilled in the art within the technical scope disclosed in this application shall fall within the protection scope of this application. In addition, based on the implementations provided in the foregoing aspects of this application, more implementations may be provided by further combinations. Therefore, the protection scope of this application shall be subject to the protection scope of the claims.

What is claimed is:

1. A method for data transmission, performed by a first terminal device, and the method comprising:
initiating, in a first network environment, a connection request for a second terminal device, to obtain a first connection identifier and a second connection identifier that are used for the first network environment, the first terminal device and the second terminal device being located in the first network environment, and the first network environment comprising a transmission gateway used for data packet forwarding;
requesting to establish a first data transmission tunnel with the transmission gateway according to the first connection identifier, and requesting to establish a second data transmission tunnel with the transmission gateway according to the second connection identifier; and
performing data transmission with the second terminal device via the first data transmission tunnel or the second data transmission tunnel.

2. The method according to claim 1, wherein performing data transmission with the second terminal device by using the first data transmission tunnel or the second data transmission tunnel comprises:
determining availability of the first data transmission tunnel;
performing, in a determination that the first data transmission tunnel is available, data transmission with the second terminal device via the first data transmission tunnel, a transmitted data packet carrying the first connection identifier; and
performing, in a determination that the first data transmission tunnel is unavailable, data transmission with the second terminal device via the second data transmission tunnel, a transmitted data packet carrying the second connection identifier.

3. The method according to claim 2, further comprising:
determining that the first data transmission tunnel is available when it is identified that the first data transmission tunnel is successfully established and is not disconnected; and
determining that the first data transmission tunnel is unavailable when it is identified that the first data transmission tunnel is not successfully established, or is successfully established but disconnected.

4. The method according to claim 1, wherein the first terminal device and the second terminal device are further located in a second network environment, and have a data transmission link in the second network environment.

5. The method according to claim 4, wherein::
for the first terminal device and the second terminal device, a multi-network transmission system formed based on the first data transmission tunnel, the second data transmission tunnel, and the data transmission link comprises a multi-network transmission controller; and
initiating, in the first network environment, the connection request for a second terminal device comprises:
transmitting the connection request for the second terminal device to the multi-network transmission controller in the first network environment; and
obtaining the first connection identifier and the second connection identifier from the multi-network transmission controller.

6. The method according to claim 2, wherein a header of the transmitted data packet comprises a connection identifier field, the connection identifier field carrying the first connection identifier or the second connection identifier.

7. The method according to claim 6, wherein the first data transmission tunnel and the second data transmission tunnel are established according to a multi-path quick user datagram protocol (UDP) Internet connections (MP-QUIC) protocol, and the transmitted data packet is a QUIC data packet.

8. The method according to claim 1, wherein the first network environment is a 5th-generation (5G) mobile communication technology network environment, and the first data transmission tunnel is a 5G local area network (LAN) tunnel.

9. A method for data transmission, performed by a forwarding node in a first network environment, comprising:
determining, upon receiving a data packet transmitted by a first terminal device to a second terminal device, a to-be-identified connection identifier carried in the data packet, the first terminal device and the second terminal device being located in the first network environment;
determining a connection identifier carried in the data packet;
in response to connection identifier being a first connection identifier in a first connection identifier set, forwarding the data packet to the second terminal device by using a target data transmission tunnel, the target data transmission tunnel being a data transmission tunnel established between the second terminal device and the forwarding node via the first connection identifier; and
in response to that the connection identifier being a second connection identifier in a second connection identifier set, forwarding the data packet to a transmission gateway in the first network environment by using a second data transmission tunnel, to cause the transmission gateway to forward the data packet to the second terminal device via a third data transmission tunnel.

10. The method according to claim 9, wherein the third data transmission tunnel is a data transmission tunnel established between the second terminal device and the transmission gateway by using a third connection identifier, and the third connection identifier belongs to the second connection identifier set; and
when the data packet is forwarded to the second terminal device via the third data transmission tunnel, the connection identifier carried in the data packet is the third connection identifier.

11. The method according to claim 9, wherein forwarding the data packet to the second terminal device via the target data transmission tunnel comprises:
querying, according to a public network destination address of the second terminal device carried in the data packet, an intranet access address corresponding to the public network destination address; and
replacing the public network destination address in the data packet with the intranet access address to obtain a replaced data packet, and forwarding the replaced data packet to the second terminal device by using the target data transmission tunnel.

12. The method according to claim 11, further comprising:
storing a correspondence between the first connection identifier and the intranet access address, the correspondence being used for determining a corresponding intranet access address according to the correspondence when a data packet carrying the first connection identifier is obtained next time.

13. A first terminal device comprising a memory for storing computer instructions and a processor in communication with the memory, wherein, when the processor executes the computer instructions, the processor is configured to cause the first terminal device to:
initiate, in a first network environment, a connection request for a second terminal device, to obtain a first connection identifier and a second connection identifier that are used for the first network environment, the first terminal device and the second terminal device being located in the first network environment, and the first network environment comprising a transmission gateway used for data packet forwarding;
request to establish a first data transmission tunnel with the transmission gateway according to the first connection identifier, and requesting to establish a second data transmission tunnel with the transmission gateway according to the second connection identifier; and
perform data transmission with the second terminal device via the first data transmission tunnel or the second data transmission tunnel.

14. The first terminal device according to claim 13, wherein, when the processor is configured to cause the first terminal device to perform data transmission with the second terminal device by using the first data transmission tunnel or the second data transmission tunnel, the processor is configured to cause the first terminal device to:
determine availability of the first data transmission tunnel;
in a determination that the first data transmission tunnel is available, perform, data transmission with the second terminal device via the first data transmission tunnel, a transmitted data packet carrying the first connection identifier; and
in a determination that the first data transmission tunnel is unavailable, perform data transmission with the second terminal device via the second data transmission tunnel, a transmitted data packet carrying the second connection identifier.

15. The first terminal device according to claim 14, wherein, when the processor executes the computer instructions, the processor is configured to further cause the first terminal device to:
determine that the first data transmission tunnel is available when it is identified that the first data transmission tunnel is successfully established and is not disconnected; and
determine that the first data transmission tunnel is unavailable when it is identified that the first data transmission tunnel is not successfully established, or is successfully established but disconnected.

16. The first terminal device according to claim 13, wherein the first terminal device and the second terminal device are further located in a second network environment, and have a data transmission link in the second network environment.

17. The first terminal device according to claim 16, wherein:
for the first terminal device and the second terminal device, a multi-network transmission system formed based on the first data transmission tunnel, the second data transmission tunnel, and the data transmission link comprises a multi-network transmission controller; and
when the processor is configured to cause the first terminal device to initiate, in the first network environment, the connection request for the second terminal device, the processor is configured to cause the first terminal device to:
transmit the connection request for the second terminal device to the multi-network transmission controller in the first network environment; and
obtain the first connection identifier and the second connection identifier from the multi-network transmission controller.

18. The first terminal device according to claim 14, wherein a header of the transmitted data packet comprises a connection identifier field, the connection identifier field carrying the first connection identifier or the second connection identifier.

19. The first terminal device according to claim 18, wherein the first data transmission tunnel and the second data transmission tunnel are established according to a multi-path quick user datagram protocol (UDP) Internet connections (MP-QUIC) protocol, and the transmitted data packet is a QUIC data packet.

20. The first terminal device according to claim 13, wherein the first network environment is a 5th-generation (5G) mobile communication technology network environment, and the first data transmission tunnel is a 5G local area network (LAN) tunnel.
